(19) United States
(12) Patent Application Publication
(10) Pub. No.: US 2006/0235552 A1
(43) Pub. Date: Oct. 19, 2006

(54) Method and system for media content data distribution and consumption

(75) Inventors: Constantine N. Manis, Monmouth Junction, NJ (US); Oleg Logvinov, East Brunswick, NJ (US); Lawrence F. Durfee, Washington, NJ (US)

Correspondence Address: Peter F. Snell;Mintz Levin Cohn Ferris Glovsky and Popeo PC, Chrysler Center, 666 Third Avenue, 24th Floor, New York, NY, 10017, US

(73) Assignee: ARKADOS, INC., North Plainfield, NJ (US)

(21) Appl. No.: 11/407,687

(22) Filed: Apr. 19, 2006

Related U.S. Application Data
(63) Continuation of application No. 10/293,129, filed on Nov. 13, 2002, now abandoned.
(60) Provisional application No. 60/338,158, filed on Nov. 13, 2001.

(51) Int. Cl. G06F 17/00

(52) U.S. Cl. 700/94

(57) ABSTRACT

A time synchronization beacon, which includes a plurality of timing signals at a plurality of different respective carrier frequencies, is synchronously transmitted over a power line network to synchronize consumption of media content data, such as audio data, which has been transmitted over the network from a power line communications (“PLC”) audio source to PLC equipped media content consumption devices, such as stereo audio speaker sets. The sets of speakers can be located in different respective rooms throughout a facility. The audio data can be in the form of network audio network data packets including one or more channels of audio data. The PLC consumption devices select which transmitted channel data is received and consumed. The beacon coordinates the start time of consumption of segments of audio data samples, and the sample-to-sample consumption time interval at PLC equipped consumption devices. The network packets can be addressed for desired PLC consumption devices using PLC network addressing methods.

### CROSS REFERENCE TO RELATED APPLICATION

This application claims the benefit of U.S. Provisional Application No. 60/338,158 filed Nov. 13, 2001, which is incorporated by reference herein.

### FIELD OF THE INVENTION

This invention relates to distribution of media content data to a plurality of media content data consumption points and, more particularly, to system and method for distributing audio data over a power line network to achieve time synchronized consumption of the audio data at audio data consumption points.

### BACKGROUND OF THE INVENTION

Sources of audio data signals that are found in and around homes or offices include televisions, radios, home entertainment systems and personal computers. The audio data may be monaural (single channel), stereo (dual channel) or multi-channel, as in AC-3, MPEG1, MPEG2, DOLBY, etc., and also in the form of streaming media obtained from stored data or Internet sources.

Traditionally, each room in a facility, e.g., home, office, etc., includes its own independent audio data signal source. For example, in a home, a separate audio system, including a single audio receiver source and one or more speakers connected to the source, may be located in a recreation room, and another, different audio system may be located in a living room. In each room, the audio source is connected by conventional audio source output wire, e.g., speaker wire, to each speaker within the room. This approach for providing audio sound in a facility can be expensive. High quality receivers can be costly. In addition, a home may have limited space for storage of media equipment. Furthermore, having multiple systems in several rooms involves installation complications, such as substantial wiring for speakers, Internet access, etc.

It is also known to use conventional electrical power lines found in a home to distribute audio data signals from an audio source to multiple speakers located throughout the home. A power line communications (“PLC”) network, however, is a dynamic network including elements that are switched in and out randomly by a customer, or automatically. Also, the power line network can include segments that from time to time are subject to varying levels of noise injection and frequency selective attenuation. These conditions can cause power line impedance levels, frequency selectivity parameters and noise levels to change. In other words, every pair of communications points in a PLC network has a unique set of transmission and reception characteristics that vary over time. As a result of the varying communications network signal transmission characteristics and traffic loading and parameters of the communication network itself, delays on a PLC network may vary greatly at any given time based on available bandwidth, re-transmission rates, etc.

The signal transmission delays associated with the PLC network, thus, can cause the undesirable result that the audio signals arrive at audio data consumption points, e.g., speakers, at different times. Conversion of multi-channel audio data to audio sound, however, needs to occur at the same time at each of the consumption points. Consequently, although using the power lines for audio data signal distribution eliminates the added expense of installing the substantial wiring required for connecting multiple speakers to an audio source, the problem of achieving time synchronized consumption of audio data at the speakers connected to the source is present.

A need, therefore, exists for an easy and inexpensive system and method for distributing audio data from an audio source to provide that audio sound generated at audio data consumption points is time synchronized based on relationships between or among audio data consumption points.

### SUMMARY OF THE INVENTION

In accordance with the present invention, a power line communications (“PLC”) media content data distribution and consumption system provides for time synchronized consumption of media content data, such as audio data, which has been transmitted from a PLC media content data source, such as a PLC audio data signal source, to a plurality of addressable PLC media content data consumption points, such as PLC equipped speakers, over a conventional power line network.

In a preferred embodiment, a PLC audio data distribution and consumption system includes a PLC audio source controller, which generates encoded digital audio data signals and asynchronously transmits such signals over the power line network. In addition, the PLC source controller generates and transmits over the power line network synchronous time synchronization signals. The system further includes at least one addressable PLC consumption point controller for receiving and processing the data signals transmitted by the PLC source over the power line network. The synchronous time synchronization signals provide for time-synchronized consumption of the audio data at audio data consumption points, e.g., speakers, which are respectively coupled to the PLC consumption point controllers. At each of the PLC consumption point controllers, the synchronization signals control conversion of the received digital audio data to an analog form suitable for driving the speaker, such that the speakers of the PLC audio system generate audio sound in a time synchronized manner.

In a preferred embodiment, the time synchronization signals are in the form of a network synchronizing beacon having timing signals at different respective frequencies to account for variations in the signal transmission dynamics of the power line network. In an alternate embodiment, the network synchronization beacon includes data which the PLC consumption controller uses (i) to control the intervals between consumption of audio data having selected sequence numbers which are available for consumption at a PLC consumption point, and (ii) to identify the stream of audio data packets to be consumed at a PLC consumption point based on the source identifier data included in the audio packets.

In a preferred embodiment, the audio data is distributed as a payload of network audio packets, includes data associated with one or more audio channels and is in either compressed or uncompressed format. In a further preferred embodiment, each audio packet includes sequence number and audio source identifier data.

### BRIEF DESCRIPTION OF THE DRAWINGS

Other objects and advantages of the present invention will be apparent from the following detailed description of the presently preferred embodiments, which description should be considered in conjunction with the accompanying drawings in which:

FIG. 1 is a block diagram of an exemplary PLC audio data signal distribution and consumption system including a plurality of PLC equipped speakers located in different rooms and coupled to one another and to a PLC audio source over a power line network, in accordance with a preferred embodiment of the present invention.

FIG. 2 is a block diagram of the PLC audio source of the system of FIG. 1 in accordance with a preferred embodiment of the present invention.

FIG. 3 is a block diagram of a PLC equipped speaker of the system of FIG. 1, in accordance with a preferred embodiment of the present invention.

FIG. 4 is a graphical illustration of signal transmission characteristics in the system of FIG. 1, in accordance with a preferred embodiment of the present invention.

FIG. 5 is a block diagram illustrating distribution of a plurality of channels of audio data in a single packet in the system of FIG. 1, in accordance with a preferred embodiment of the present invention.

FIG. 6 is a block diagram illustrating distribution of a single channel of audio data in a single packet in the system of FIG. 1, in accordance with a preferred embodiment of the present invention.

### DETAILED DESCRIPTION

The present invention for providing synchronized consumption of distributed media content data at a plurality of media content data consumption points, where the content is distributed from a PLC data source over a PLC network, is illustrated below in connection with a PLC audio source controller which is coupled to an audio entertainment source and asynchronously transmits, over existing, conventional electrical power conveying media, i.e., the electric power line network, of a building, encoded digital audio data signals for receipt at at least one of a plurality of addressable PLC audio data consumption controllers located throughout the building. Each of the PLC source and consumption controllers is plugged into a conveniently located electric wall outlet. The PLC source controller, in accordance with present invention, generates and transmits synchronous time synchronization timing signals, having minimal or no data modulated thereon, over the power line network. The PLC consumption point controllers receive from the power line network the encoded digital audio data signals and the synchronization signals, and use the latter to achieve synchronized consumption of the digital audio data contained in the encoded signals, such that the speakers respectively coupled thereto generate synchronized audio sound. The ability to distribute single and multi-channel audio data over a power line network to a plurality of PLC equipped speakers and obtain synchronized audio data consumption at the speakers advantageously permits easy and inexpensive installation of additional audio data consumption points, i.e., speakers, within the building.

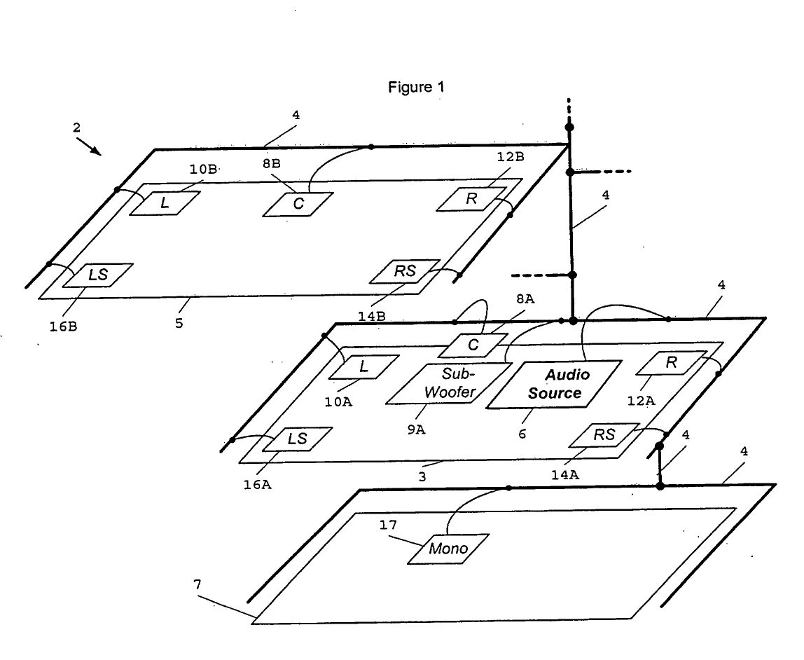

FIG. 1 shows a preferred embodiment of a home installation of a PLC audio data distribution and consumption system 2 that distributes audio data to rooms 3, 5 and 7 over a conventional, electric power line network 4. The room 3 contains a PLC audio source 6 and addressable PLC equipped speakers 8A, 9A, 10A, 12A, 14A and 16A, each of which are coupled to the network 4. The room 5 contains addressable PLC equipped speakers 8B, 10B, 12B, 14B and 16B coupled to the network 4. The room 7 contains an addressable PLC equipped monaural speaker 17 coupled to the network 4. As described in detail below, the PLC source 6 preferably includes conventional audio source equipment, including Internet access and other media features. The PLC speakers 8, 9, 10, 12, 14, 16 and 17 preferably include conventional speaker components, such as a mid-range, tweeter and woofer, and also can be in the form of headphones.

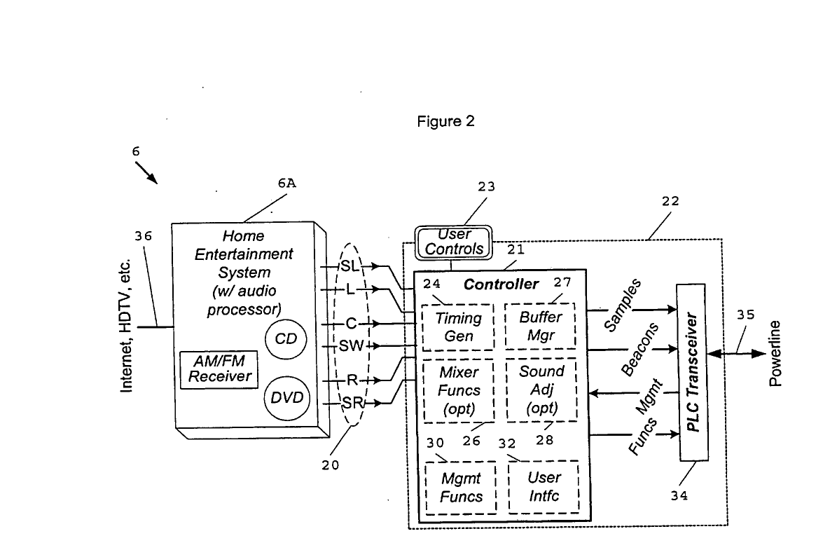

FIG. 2 illustrates a preferred embodiment of the PLC audio source 6 of the system 2. Referring to FIG. 2, the audio source 6 includes a conventional home entertainment system 6A coupled to a PLC source module 22. The home entertainment system 6A can include elements such as an AM/FM radio receiver, a CD player, a digital video device (“DVD”) and a sound processor sub-system, such as a proprietary DOLBY, Qsound, etc., system. In addition, the system 6A includes a digital audio data connection port 36 to which an Internet or high-definition television (“HDTV”) audio signal source can be connected. Audio signal output line 20, which in a preferred embodiment includes lines left 20L, right 20R, center 20C, left surround 20LS, right surround 20RS and sub-woofer 20SW, couples the PLC source module 22 to a conventional audio speaker driver output of the source 6A. In an alternative preferred embodiment, the system 6A includes other forms of analog audio or digital connection ports, such as SONY/PHILIPS digital interface (“S/PDIF”), to which the line 20, which can be a medium for conveying digital or optical signals, is coupled.

The PLC source module 22 includes a PLC controller 21, which is coupled to a PLC transceiver and a user control panel interface 23. The PLC transceiver 34 is coupled to a power line connection 35. In a preferred embodiment, the controller 21 includes the functional blocks of a timing generator module 24, which generates the time synchronization signals discussed in greater detail below, a sound mixer module 26, a buffer manager module 27, a sound adjustment module 28, a management function module 30 and a user interface module 32. It is to be understood that each of the functional blocks of the inventive PLC controllers which are described below as performing data processing operations constitutes a software module or, alternatively, a hardware module or a combined hardware/software module. In addition, each of the modules suitably contains a memory storage area, such as RAM, for storage of data and instructions for performing processing operations in accordance with the present invention. Alternatively, instructions for performing processing operations can be stored in hardware in one or more of the modules.

Referring to FIGS. 1 and 2, the PLC audio source 6 generates and transmits over the network 4 encoded digital audio data signals, interrogation signals and time synchronization signals for receipt by at least one of the PLC equipped speakers 8, 9, 10, 12, 14, 16 and 17 located in the rooms 3, 5 and 7. The PLC source module 22 generates the encoded digital audio data signals based on single or multi-channel analog or digital audio signals provided at an optical or S/PDIF output of the source 6A and transmitted over the line 20. Alternatively, the PLC source module 22 generates the encoded digital audio data signals based on the analog audio driving signals on the line 20 which the source 6A, in a legacy system application, provides at the output for driving conventional speakers.

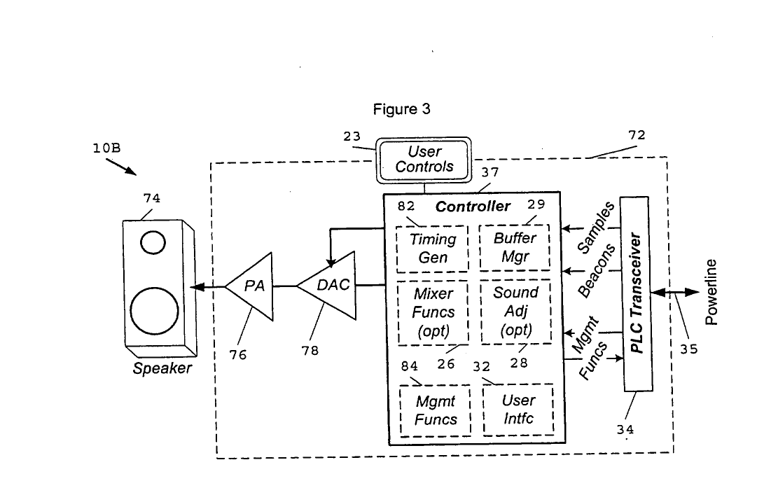

In a preferred embodiment, the modules at the PLC source module 22 perform the following operations in connection with generating the encoded audio data signals for distribution over the power line network 4, based on the audio signals received over the line 20. Referring to FIG. 2, the mixer module 26 adjusts, for example, stereo audio signals received from the source 6A to form a single channel data stream, which is only for distribution to a consumption point coupled with a monaural speaker. The sound adjustment module 28 performs sound adjustments to the audio data, such as balance adjustments, bass and treble adjustment, etc., as required. The interface module 32 performs audio processing, such as balance and tone adjustments and mixing option selects, etc., as needed or as selected by a user at the user control interface 23. As discussed below in the text accompanying the description of FIG. 3, the functions performed at the modules 26, 28 and 32 alternatively can be performed at the PLC equipped speakers, if desired, and no loss in functionality will be incurred.

The PLC transceiver 34 is a conventional device, such as described in HomePlug Standard Brings Networking to the Home, Communications System Design Magazine Vol. 16, No. 12 (December 2000), incorporated by reference herein, which has been adapted to operate in combination with the controller 21 to transmit synchronous time synchronization signals in accordance with the present invention. The power connection 35 is a conventional electric power line cord with a dual prong end for plugging into a conventional electrical wall outlet. The connection 35 can provide electrical power to the PLC source 6 in addition to facilitating data communications between the PLC source and the PLC equipped speakers over the network 4. The interface 23 is a conventional user display control device, such as a touch screen or an alphanumeric keypad controlled by the module 32.

The buffer module 27 generates the encoded digital audio signals as streams of network audio packets including a payload of digitized audio data samples. Each audio packet includes single or multiple channel audio data and can contain multiple audio data samples. In a preferred embodiment where the source 6A provides at an S/PDIF output port digital audio data samples for transmission to the PLC source module 22 over the line 20, the controller 21 places each digital audio data sample directly into an audio packet, without additionally processing. Consequently, digital audio data associated with a proprietary sound processing system, such as DOLBY, AC-3, QSound, etc., or obtained from a digital audio source, such as a CD player, is used without modification in accordance with the present invention. The module 30 adds sequence information and audio source identification data to the data stream to, respectively, identify the packets in terms of sequential order and as corresponding to audio data obtained from a specific audio source, such as a DVD.

In addition, the module 30 generates the interrogation signals which are used to determine other operating parameters, such as encryption, device capabilities, etc., of the PLC equipped speakers of the system 2. Based on information that the PLC source 6 receives from the PLC equipped speakers in response to the interrogation signals, the module 30 suitably performs other suitable processing on the audio data, which can result in the inclusion of additional operating parameter data with the audio packets.

The timing module 24 generates the time synchronization signals which the PLC transceiver 34 synchronously transmits, preferably in the form of sets of network synchronization beacons including timing signals at different respective frequencies, over the network 4. The beacons provide for time synchronized consumption of audio data at the PLC equipped speakers in accordance with the present invention, as described in detail below. In an alternative embodiment, the timing module 24 includes time stamp data with each packet.

FIG. 3 illustrates a preferred embodiment of the PLC equipped speaker 10B of the system 2 in accordance with the present invention. It is to be understood that the other PLC equipped speakers in the system 2 have identical or substantially identical construction and operation as described below for the PLC speaker 10B. In addition, like reference numerals are used to identify components having an identical, or substantially identical, construction and operation as components described above. Referring to FIG. 3, the PLC speaker 10B includes a PLC consumption point module 72 coupled to a conventional speaker 74. The PLC consumption module 72 includes a controller 37 coupled to a digital analog converter (“DAC”) 78. An audio power amplifier 76 in the module 72 couples the DAC 78 to the speaker 74. A PLC transceiver 34 couples the controller 37 to a power line connection 35.

Referring again to FIG. 3, the controller 37 includes a mixer module 26, a sound adjustment module 28, a buffer management module 29, a user interface 32, a timing function module 82 and a management function module 84. The modules 26 and 28 of the controller 37 have identical or substantially identical construction and can perform the identical or substantially identical operations of adjusting and mixing as described previously for the controller 21, if such operations are not performed at the PLC source 6. The modules 29, 82 and 84 operate, as described below, to process the interrogation signals, encoded digital audio signals and the time synchronization signals transmitted by the PLC source 6, and generate and transmit signals responsive to the interrogation signals to the PLC source 6, to achieve time synchronized consumption of audio data at the PLC equipped speaker in accordance with the present invention.

In a preferred embodiment, the PLC source 6 does not perform sound adjustment processing on the audio signals received from any audio source before placing the audio data into packets. In this embodiment, the management module 84 for the monaural speaker PLC speaker 17 provides that the mixer module 26 processes any dual channel audio data signals to form the single channel audio signals required to drive the monaural speaker 74 contained within the PLC speaker 17. In an alternative preferred embodiment, the mixer module 26 of the PLC source 6 mixes the stereo audio data to form single channel audio signals and the module 84 at the PLC equipped speaker 17 detects the presence of such processed data, such that no such mixing processing is performed therein.

After the timing module 82 determines that a time synchronization signal has been received, the module 84 causes the digital audio data samples received from the PLC source 6 to be transmitted to the DAC 78. The DAC 78 converts the digital audio samples to analog form and provides them to the power amplifier 76. In turn, the power amplifier 76 generates and transmits audio drive signals to cause the speaker 74 to generate audio sound.

In accordance the present invention, the PLC source 6 and PLC equipped speakers in the system 2 exchange data signals to provide for time synchronized consumption of the audio data at the PLC equipped speakers. Referring to FIGS. 1, 2 and 3, in a preferred embodiment, the management functions module 30 of the PLC source 6 generates interrogation data signals which the transceiver 34 transmits over the network 4. Each of the PLC equipped speakers receives these interrogation signals and the management module 84 at each of the PLC speakers, in response, transmits an encoded response data signal back to the source 6 over the network 4. The response signal includes details of the capabilities and requirements of the PLC equipped speaker, such as, for example, whether it corresponds to a right speaker of a DOLBY system and its PLC address. The module 30 receives and processes the various response signals received from the PLC equipped speakers to determine the operating requisites of the PLC equipped speakers and stores such information in its memory. Based on the information provided in the response signals from the PLC equipped speakers, the management functions module 30 includes the necessary data with each audio data stream.

As the module 30 completes generation of encoded digital audio packets containing all necessary information, the transceiver 34 of the PLC source 6 asynchronously transmits the encoded digital audio signals over the network 4 for reception at one or more of the PLC equipped speakers. In a preferred embodiment, each transmitted packet includes sequence information, which is applied by the buffer module 27.

At each of the PLC equipped speakers, the buffer module 29 extracts, as suitable, the audio data from the encoded digital audio data signals and stores the audio data in its memory. Further, the module 29 monitors the amount of digital audio data stored in its memory. When a sufficient amount of audio data has been stored, such that audio sound can be generated substantially continuously at the speaker 74, the management module 84 transmits a buffer ready signal to the PLC source 6 over the network 4.

In a preferred embodiment, when the controller 21 detects such buffer ready signal from all of the speakers in the room 3, the timing generator 24 generates a time synchronization beacon, which includes a plurality of timing signals at different respective frequencies, and the transceiver 34 transmits this time synchronization beacon over the network 4. In accordance with the present invention, the time synchronization beacon is expected to be received at exactly, or substantially exactly, the same time at each of the PLC equipped speakers in the room 3. In a preferred embodiment, the time synchronization beacon ensures that every PLC equipped speaker in the room 3 generates audio sound in a time-synchronized manner. In other words, the start of audio data consumption and also the consumption of audio data on a sample-by-sample basis is time synchronized among the related speakers in the room 3, such as in DOLBY 5.1 surround sound for the PLC equipped speakers of the room 3, based on the audio data provided from the PLC source 6. Referring to FIG. 3, the timing module 82, at a controlled start time which is based on receipt of the time synchronization beacon, sends the stored audio samples associated with an identified audio source, in sequence order to the DAC 78. The audio power amplifier 76, in turn, generates audio driving signals which are provided to the speaker 74. The start of consumption of the audio data stored at all of the other PLC equipped speakers in the room 3 is performed simultaneously or substantially simultaneously, to result in synchronized audio sound generation. In a preferred embodiment, the beacon maintains synchronized consumption of the packets by interval at all of the PLC equipped speakers in the room 3.

In a preferred embodiment, the timing generator 24 generates a plurality of multi-tone beacons, each of which includes timing signals at different respective carrier frequencies. Further, the generator 24 causes the transceiver 34 to transmit these beacons at regular intervals to synchronize the start of audio data consumption and the interval between consumption of audio data samples between or among related PLC equipped speakers. Multiple beacons at different respective ranges of frequencies are advantageous because the power line network 4 can and often does attenuate signals selectively, by frequency. In addition, the degree of attenuation changes as loads are transferred across the network 4 and noise sources, such as, hair dryers, vacuum cleaners, etc., are switched on and off the network 4.

In a preferred embodiment, the system 2 includes a plurality of PLC audio sources that are identical, or substantially identical, in construction and operation to the S PLC audio source 6. Each of the PLC audio sources generates multiple beacons, where the frequencies of the timing signals of the respective beacons are selected so as not to overlap and to correspond to frequencies useable and available for the power line network 4. The set of beacons, therefore, provides the timing for the audio data received and stored at the PLC equipped speaker. In other words, the set of beacons provides for control of the timing of audio data sample-to-sample consumption at the PLC equipped speakers at which the audio data were received and stored, and of the exact time at which the stored digital audio data samples begin to be sent to the DACs of the respective PLC speakers.

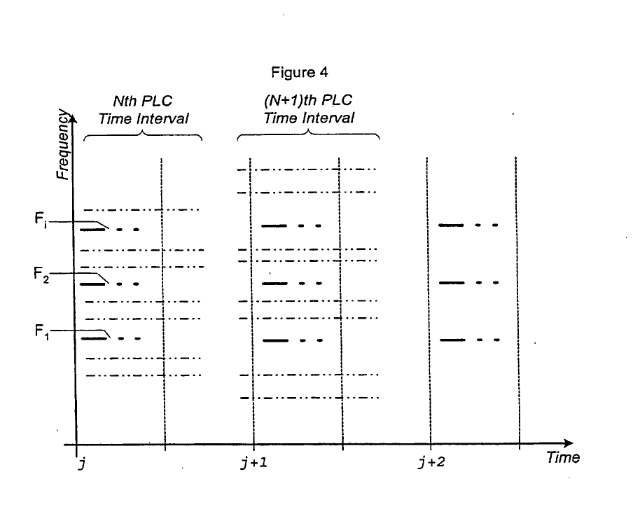

FIG. 4 is a graphical illustration of signal transmission by the PLC source 6 and the PLC equipped speakers 8, 9, 10, 12, 14, 16, 17 and 18 in a preferred embodiment of the system 2. Referring to FIG. 4, the PLC source 6 transmits, at selected time intervals j, j+1, j+2, etc., a beacon A including a plurality of timing signals having different respective carrier frequencies f₁, f₂, . . . fᵢ. The carrier frequencies f₁, f₂, . . . fᵢ are reserved solely for the timing signals of the beacon A. Data signals other than time synchronization signals, such as audio data signals, interrogation signals and response signals, are transmitted by the PLC source 6 or the PLC speakers of the system 2 only at frequencies other than the carrier frequencies reserved for the beacon. Referring again to FIG. 4, the PLC source 6 can transmit the beacon A at the same time that it transmits data signals that are not time synchronization signals, such as part of PLC time intervals N and N+1 which are transmitted at times j and j+1, respectively.

In a preferred embodiment, the PLC source 6 transmits encoded, orthogonal frequency division multiplexed (“OFDM”) digital data signals including audio data and further including a beacon. The beacon can be included anywhere within the encoded OFDM signal, such as, for example, in the link layer or the protocol layer.

In a further preferred embodiment of the system 2, multiple PLC data sources, such as additional PLC audio sources, operate on the PLC network 4, in addition to the PLC source 6. Also, the PLC source 6 transmits the beacon as part of an encoded OFDM signal and each of the other PLC sources can control, i.e., become the master, of the PLC network 4 data channel, thereby prevent any other PLC source for transmitting a data stream on the network 4. Consequently, in this embodiment, the other PLC sources can prevent the PLC source 6 from gaining mastery of the PLC network 4 data channel, which would delay the PLC source 6 from transmitting a beacon at a desired time as part of an encoded OFDM signal. In such circumstances, the PLC source 6 provides that, when the OFDM signal with the beacon is eventually transmitted, the beacon includes data to permit the PLC equipped speakers of the system 2 to compensate for the delay in the transmission of the beacon which caused by another PLC source controlling the network 4 data channel.

Referring again to FIG. 4, in another preferred embodiment, the beacon A is transmitted at a time j+2 and not included within an encoded data signal transmission, such as encoded OFDM signal. In this embodiment, the PLC source 6 transmits the beacon at a desired time and mastery of the data channel of the network 6 is not an issue.

In a further preferred embodiment of the system 2, the system 2 includes additional PLC audio sources and related sets of PLC equipped speakers, where each of the PLC sources transmits a beacon. The carrier frequencies of the timing signals of the beacons that the PLC audio sources utilize is determined, for example, by negotiation among the PCL sources or based on data included at a multiple PLC audio sources. In accordance with the present invention, selected carrier frequencies are reserved for the beacons and the PLC system devices transmit data signals other than time synchronization signals at frequencies other than the selected, beacon carrier frequencies. In a preferred embodiment, the frequencies of the timing signals for the beacons are determined based on the instantaneously available carrier frequencies and vary over time depending on network conditions.

In a preferred embodiment of the system 2 having a plurality of PLC audio sources including a single, central PLC audio source, the central PLC source generates and transmits the beacon for all of the PLC consumption points. The central PLC audio sources communication with the other than PLC audio sources to provide that the central PLC audio source generates and transmits a suitable beacon. For example, if the audio data is distributed at different sampling frequencies, such as 48 KHz and 8 KHz, the beacon is generated to ensure time synchronization with all of the consumption points and supply an interval rate useable for all of the consumption points. In a preferred embodiment, the central PLC audio source operates to coordinate timing intervals among all sets of related PLC consumption points, such as a set of DOLBY speakers.

In a preferred embodiment, the synchronous beacon signals are established by a standard collection of communications parameters, such as frequency, robust modulation technique, data format, etc., associated with a PLC consumption controller. The parameters are preferably selected to reduce the impact of the additional functionality on the technologies involved. For example, the frequencies chosen for the timing signals of the beacons correspond to those existing for that technology, i.e., in-band beacons.

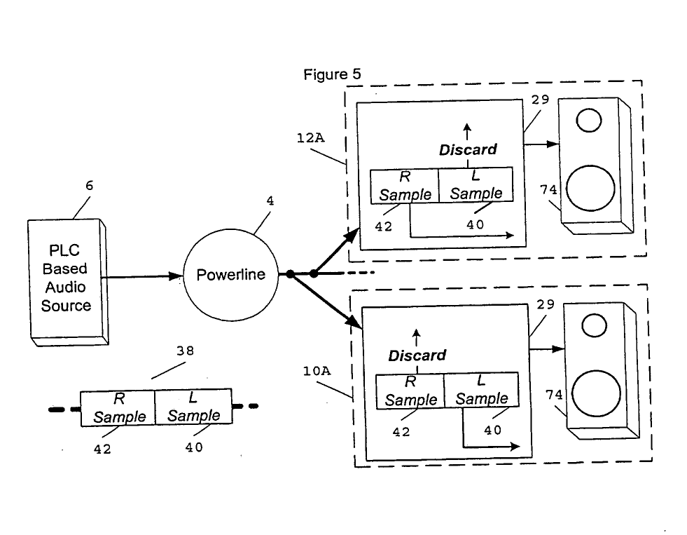

FIG. 5 illustrates processing of encoded digital audio data signals at the PLC speakers 10A and 12A of the system 4, in accordance with a preferred embodiment of the present invention. Referring to FIG. 5, and also to FIGS. 1, 2 and 3, the PLC source 6 generates audio data packets 38 including left and right channel audio data samples 40 and 42, respectively, and the transceiver 35 of the PLC source 6 transmits these samples over the network 4. The packets 38, which include data only for the PLC speakers 10A and 12A, are received at all of the PLC equipped speakers of the system 2. At each of the speakers 10A and 12A, the buffer module 29 extracts from the audio data packets 38 the audio channel data associated with and necessary to drive the respective speaker 74. For example, as the PLC equipped speaker 10A is a designated left speaker, the buffer module 29 only extracts the left audio sample data packet 40, stores such data in its memory and discards the remaining right sample data 42. In addition, as the PLC equipped speaker 12 is a designated right speaker, the buffer module 29 only extracts the right audio sample data packet 42, stores such data in its memory and discards the remaining left sample data 40. Based on networking addressing, the remainder of the PLC equipped speakers in the system 2 discard the entirety of the received packets 38.

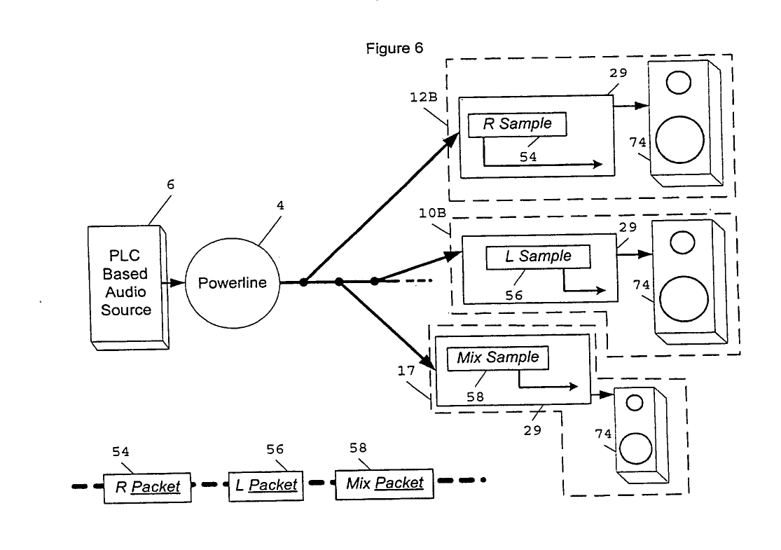

FIG. 6 illustrates processing of encoded digital audio data signals at the PLC speakers 10B, 12B and 17, in accordance with another preferred embodiment of the present invention. Referring to FIGS. 1, 2 and 3 and FIG. 6, the PLC source 6 generates audio data packets 54 and 56 addressed for the PLC equipped speakers 10A and 12B in the room 5 and audio data packets 58 addressed for the PLC equipped speaker 17 in the room 7. The packets 54, 56 and 58 are received and processed only at the PLC equipped speaker having a PLC destination address corresponding to the address of the audio packet.

In a further preferred embodiment, the mixer module 26 in the PLC audio source 6 mixes down multiple signals, such as stereo audio data, and the sound module 28 performs gain adjusted summation to form the single channel packet 58 designated for reception by and having the PLC address of the monaural PLC equipped speaker 17. The PLC source 6 suitably transmits a beacon over the network to control when the audio channel data 54, 56 and 58 stored at the respective PLC speakers 10B, 12B and 17 are converted to analog form to drive the respective speakers 74 in a time synchronized manner. For example, the beacon is transmitted to cause the PLC equipped speakers 10B and 12B to generate stereo sound based on the received audio packets 54 and 56.

Although preferred embodiments of the present invention have been described and illustrated, it will be apparent to those skilled in the art that various modifications may be made without departing from the principles of the invention.

What is claimed is:

1. A system for distributing audio data over a conventional power line network comprising:
at least one power line communications (“PLC”) audio data source for generating and transmitting over the power line network encoded digital audio data signals including at least one audio channel and for generating and transmitting over the power line network at least one synchronous time synchronization signal; and
at least one PLC equipped audio data consumption device for coupling to the power line network and to an audio sound generator and for receiving the data signals transmitted by the PLC source, wherein the PLC consumption device upon receipt of the time synchronization signal generates time synchronized audio driving signals for driving the sound generator, wherein the audio driving signals are obtained based on the encoded digital audio signals received at the PLC consumption device.

2. The system according to claim 1, wherein the at least one PLC consumption device includes a plurality of PLC consumption devices, wherein the encoded digital audio data signals include a single network audio packet containing single channel audio data, wherein the packet is received by the plurality of the PLC consumption devices.

3. The system according to claim 1, wherein the at least one PLC consumption device includes a plurality of PLC consumption devices, wherein the encoded digital audio data signals include a single network audio packet containing multiple channel audio data, wherein the packet is received by the plurality of the PLC consumption devices.

4. The system according to claim 1, wherein the time synchronous signal includes a beacon including a plurality of timing signals at a plurality of different, respective frequencies.

5. The system according to claim 4, wherein the beacon and the encoded digital signals are transmitted synchronously.

6. The system according to claim 1, wherein the beacon is included within the encoded signals.

7. The system according to claim 6, wherein the beacon includes data.

8. The system according to claim 7, wherein the data includes delay data representative of a delay in the transmission of the encoded signals by the PLC source caused by at least one other PLC data source coupled to the network and operating to control signal transmission over the network.

9. The system according to claim 4, wherein the beacon and the encoded digital signals are transmitted asynchronously.

10. The system according to claim 4, wherein the at least one PLC source includes a plurality of PLC audio data sources, wherein each of the PLC sources has an assigned beacon having different, selected carrier frequencies.

11. The system of claim 10, wherein the beacons provide timed interval consumption of the audio data samples stored at the PLC consumption devices.

12. The system according to claim 10, wherein at least one of the beacons is assigned to at least one of the PLC sources to provide for time synchronized commencement of consumption of the audio data samples stored at the PLC consumption devices.

13. A method for distributing audio data over a conventional power line network comprising:
receiving audio data signals from an audio source;
generating encoded digital audio data signals based on the received audio source signals at at least one power line communications (“PLC”) audio source;
transmitting the encoded digital audio data signals over a power line network;
receiving the encoded signals at at least one PLC consumption device which is coupled to the power line network;
transmitting over the power line network a synchronous time synchronization signal generated at the PLC source for receipt by the PLC consumption device; and
generating, upon receipt of the time synchronization signal at the PLC consumption device, audio drive signals based on the encoded signals received at the PLC consumption device, wherein the audio drive signals are generated to provide for time synchronized generation of audio sound at an audio sound generator coupled to the PLC consumption device.

14. The method according to claim 13, wherein the at least one PLC consumption device includes a plurality of PLC consumption devices, wherein the encoded digital audio data signals include a single network audio packet containing single channel audio data, wherein the packet is received by the plurality of the PLC consumption devices.

15. The method according to claim 13, wherein the at least one PLC consumption device includes a plurality of PLC consumption devices, wherein the encoded digital audio data signals include a single network audio packet containing multiple channel audio data, wherein the packet is received by the plurality of the PLC consumption devices.

16. The method according to claim 13, wherein the time synchronous signal includes a beacon including a plurality of timing signals at a plurality of different, respective frequencies.

17. The method according to claim 16, wherein the beacon and the encoded digital signals are transmitted synchronously.

18. The method according to claim 13, wherein the beacon is included within the encoded signals.

19. The method according to claim 18, wherein the beacon includes data.

20. The method according to claim 19, wherein the data includes delay data representative of a delay in the transmission of the encoded signals by the PLC source caused by at least one other PLC data source coupled to the network and operating to control signal transmission over the network.

21. The system according to claim 17, wherein the beacon and the encoded digital signals are transmitted asynchronously.

22. The method according to claim 16, wherein the at least one PLC source includes a plurality of PLC audio data sources, wherein each of the PLC sources has an assigned beacon having different, selected carrier frequencies.

23. The method of claim 22, wherein the beacons provide timed interval consumption of the audio data samples stored at the PLC consumption devices.

24. The method according to claim 16, wherein at least one of the beacons is assigned to at least one of the PLC sources to provide for time synchronized commencement of consumption of the audio data samples stored at the PLC consumption devices.

25. A system for distributing media content data over a conventional power line network comprising:
at least one PLC media content data source for generating and transmitting over the power line network encoded digital media content data signals including at least one data channel and for generating and transmitting over the power line network at least one synchronous beacon including a plurality of timing signals at a respective plurality of different carrier frequencies; and
at least one PLC equipped media content data consumption device for coupling to the power line network and to a media content generator having the capability of producing at least one of sound, text and video, wherein the PLC consumption device is for receiving the data signals transmitted by the PLC source, wherein the PLC consumption device upon receipt of the beacon generates time synchronized driving signals for driving the media content generator, wherein the driving signals are obtained based on the encoded digital media content signals received at the PLC consumption device.
